(19) United States
(12) Patent Application Publication
(10) Pub. No.: US 2026/0057755 A1
(43) Pub. Date: Feb. 26, 2026

(54) Method and Device for Detecting a Fall of a Person by Means of at Least One Inertial Sensor Unit and Computer Program

(71) Applicant: Andreas Stihl AG & Co. KG, Waiblingen (DE)

(72) Inventors: Fabian HOERMANN, Heubach (DE); Nils CONRAD, Korb (DE)

(21) Appl. No.: 19/303,772

(22) Filed: Aug. 19, 2025

(30) Foreign Application Priority Data
Aug. 20, 2024 (DE) 10 2024 123 689.2

(51) Int. Cl. G08B 21/04

(52) U.S. Cl. CPC G08B 21/0446; G08B 21/043

(57) ABSTRACT

A method detects a fall of a person via at least one inertial sensor unit, which is worn by the person on a body part, in particular their head, and which is designed to record at least one inertial variable. The method includes: monitoring whether at least one first recorded inertial variable or a variable based thereon meets an impact criterion, which is characteristic for an impact of the body part; if the impact criterion is met, monitoring whether at least one second recorded inertial variable, which is recorded chronologically after the first inertial variable, or a variable based thereon meets an immobility criterion, which is characteristic for an immobility of the body part for an immobility duration, in particular of at least 30 s, and a nonvertical position criterion, in particular a horizontal position criterion, which is different from the immobility criterion and is characteristic for a nonvertical, in particular horizontal, position of the body part for a position duration, in particular of at least 30 s; and if the immobility criterion and the nonvertical position criterion are met, outputting and/or transmitting alarm information, in particular about the detected fall.

### CROSS REFERENCE TO RELATED APPLICATION

This application claims priority under 35 U.S.C. § 119 from European Patent Application No. 10 2024 123 689.2, filed Aug. 20, 2024, the entire disclosure of which is herein expressly incorporated by reference.

### BACKGROUND AND SUMMARY

The invention relates to a method and a device for detecting a fall of a person by means of at least one inertial sensor unit and a computer program for carrying out such a method and/or by means of such a device.

The invention is based on the object of providing a method and a device, in particular in each case for detecting a fall of a person by means of at least one inertial sensor unit and a computer program for carrying out such a method and/or by means of such a device, which have or has improved properties.

The invention achieves this object by providing a method, a device, and a computer program described in the independent claims. Advantageous refinements and/or embodiments of the invention are described in the dependent claims.

The method according to the invention is for recognizing a fall of a person by means of at least one inertial sensor unit. The inertial sensor unit is worn by the person on a body part, in particular their head. The inertial sensor unit is designed to record at least one inertial variable. The method comprises the following steps:
a) Monitoring whether at least one first recorded inertial variable or a variable based thereon meets an impact criterion, in particular or not. The impact criterion is characteristic for an impact of the body part, in particular of the person.
b) If, in particular at least or only, the impact criterion is met, monitoring whether at least one second recorded inertial variable or a variable based thereon meets an immobility criterion and a nonvertical position criterion, in particular horizontal position criterion, in particular or not. The second recorded inertial variable is recorded chronologically after the first inertial variable. The immobility criterion is characteristic for an immobility of the body part, in particular the person, for an immobility duration, in particular of at least 30 s (seconds), in particular at least 60 s. The nonvertical position criterion is different from the immobility criterion. The nonvertical position criterion, in particular the horizontal position criterion, is characteristic for a nonvertical, in particular horizontal, position of the body part, in particular the person, for a position duration, in particular of at least 30 s, in particular at least 60 s.
c) If, in particular at least or only, the immobility criterion and the nonvertical position criterion are met, outputting and/or transmitting alarm information, in particular about the detected fall.

This, in particular monitoring the meeting of the impact criterion, the immobility criterion, and the nonvertical position criterion, enables the fall to be detected reliably, and in particular efficiently and/or cost-effectively, for example caused by an involuntary trip over a root during forestry work, in particular and therefore whether the person, who is in particular lying on a forest floor, requires help, for example due to physical harm suffered involuntarily due to the fall, and/or enables a false alarm to be avoided.

In particular, the method, the detecting, the recording, the monitoring, the outputting, and/or the transmitting can be automatic and/or computer-implemented.

The method, step a), step b), and/or step c) can be carried out by means of a device, in particular an electrical device. In particular, the device can comprise the inertial sensor unit.
Step b) can be carried out, in particular immediately, chronologically after step a) or the monitoring that the impact criterion is met.
Step c) can be carried out, in particular immediately, chronologically after step b) or the monitoring that the immobility criterion and the nonvertical position criterion are met.

If the impact criterion is not met, step b) may not be carried out.

If the immobility criterion and/or the nonvertical position criterion is/are not met, step c) may not be carried out.

The term “take place” or the formulation “are performed” or “are implemented” can be used synonymously for the formulation “are carried out”.

The term “directly” or the formulation “without pause” can be used synonymously for the term “immediately”.

The term or term component “user” can be used synonymously for the term or term component “person”.

The person can be a natural person.

The inertial sensor unit can be worn by the person on their head.

Worn can mean fastened.

The inertial sensor unit can be electrical, in particular micro-electromechanical.

The inertial variable, in particular the first recorded or second recorded inertial variable, can include a value.

The term “configured” or “designed” or the formulation “programmed to perform the function/s of” can be used synonymously for the term “formed”.

The term “comprises” or “has” can be used synonymously for the term “includes”.

The first recorded inertial variable can be an inertial variable recorded first chronologically.

The term/term component “strike” can be used synonymously for the term/term component “impact”.

The second recorded inertial variable can be an inertial variable recorded second chronologically.

The term/term component “non-movement” or “rest” can be used synonymously for the term/term component “immobility”.

The immobility duration can be an immobility minimum duration.

The term/term component “vertical” can be used synonymously for the term/term component “upright”.

The term/term component “horizontal” can be used synonymously for the term/term component “level”.

The position can be a body position.

The position duration can be a position minimum duration.

The term/term component “at least” can be used synonymously for the term/term component “minimum”.

The impact criterion, the immobility criterion, and/or the nonvertical position criterion can be different from one another and/or predetermined.

A value of the immobility duration and a value of the position duration can be equal.

The term/term component “communicate” can be used synonymously for the term/term component “transmit”.

The alarm information can include a content and/or a value.

Moreover, reference is made to the technical literature.

In one refinement of the invention, the inertial sensor unit includes an acceleration sensor unit, and in particular a rotation rate sensor unit and/or an inclination switch unit. The inertial variable includes an acceleration variable, and in particular a rotation rate variable and/or an inclination variable. This enables monitoring only by means of real variable evaluation or data evaluation, in particular of the acceleration sensor unit or the acceleration variable, and/or by means of the additional unit or variable, in particular the inclination switch unit or the inclination variable. In particular, the acceleration sensor unit can be referred to as a g sensor unit. Additionally or alternatively, the inclination switch unit can be an inclination sensor unit having an inclination limiting value. Further additionally or alternatively, the term component “inclination angle” can be used synonymously for the term component “inclination”. Moreover, reference is made to the technical literature.

In one refinement of the invention, the impact criterion is that the first recorded inertial variable, in particular acceleration variable, or the variable based thereon exceeds an impact limiting value, in particular characteristic for at least 6 g (gravitational acceleration and/or 1 g=9.81 m/s² (meters per second squared)), in particular at least 12 g, in particular for an impact duration, in particular having a value which is as small as possible or close to 0 s. Additionally or alternatively, the immobility criterion is that the second recorded inertial variable, in particular acceleration variable, or the variable based thereon falls below an immobility limiting value, in particular characteristic for at most 0.5 g, for the immobility duration. In particular, the impact limiting value is greater, in particular at least 12 times greater, in particular at least 24 times greater, than the immobility limiting value. Further additionally or alternatively, the nonvertical position criterion is that the second recorded inertial variable, in particular inclination variable, or the variable based thereon falls below an inclination limiting value, in particular characteristic for at most 0.5 g and/or at most 45° (degrees), for the position duration. This enables the fall to be detected particularly well. In particular, the impact limiting value can be an impact minimum limiting value. Additionally or alternatively, the immobility limiting value can be an immobility maximum limiting value. Further additionally or alternatively, the inclination limiting value can be an inclination maximum limiting value. Further additionally or alternatively, the term component “threshold” can be used synonymously for the term component “limiting”. Further additionally or alternatively, the inertial variable, in particular the first recorded or second recorded inertial variable, can be at the natural gravitational acceleration of 1 g or this may not be compensated or taken into consideration, in particular subtracted. Further additionally or alternatively, the inclination limiting value can be with respect to a horizontal or a horizontal direction. Moreover, reference is made to the technical literature.

In one embodiment of the invention, the person wears an, in particular the, device. The device includes the inertial sensor unit and a time counter unit. The inertial sensor unit is designed to provide a first interrupt signal at the time counter unit as long as the first recorded inertial variable or the variable based thereon exceeds the impact limiting value. The inertial sensor unit is designed to provide a second interrupt signal at the time counter unit as long as the second recorded inertial variable or the variable based thereon falls below the immobility limiting value. The second interrupt signal is different from the first interrupt signal. The time counter unit is designed to count a duration, in particular immediately, chronologically after the provision of the first interrupt signal. During the duration, the second interrupt signal is provided, in particular without pause or interruption. The immobility criterion is that the counted duration reaches the immobility duration. In particular, the device includes a further time counter unit. The further time counter unit is designed to count a further duration, in particular immediately, chronologically after the provision of the first interrupt signal. During the further duration, the second recorded inertial variable or the variable based thereon falls below the inclination limiting value, in particular without pause or interruption. The nonvertical position criterion is that the counted further duration reaches the position duration. This enables energy-efficient operation, in particular of the time counter unit and therefore of the device. In particular, the time counter unit and/or the further time counter unit can be electrical. Additionally or alternatively, the provision and/or the counting can be automatic. Further additionally or alternatively, the interrupt signal, in particular the first or second interrupt signal, and/or the duration, in particular the further duration, can include a value. Further additionally or alternatively, the inertial sensor unit can be designed not to provide the first interrupt signal as long as the first recorded inertial variable or the variable based thereon does not exceed the impact limiting value. Further additionally or alternatively, the inertial sensor unit can be designed not to provide the second interrupt signal as long as the second recorded inertial variable or the variable based thereon does not fall below the immobility limiting value. Further additionally or alternatively, the inertial sensor unit can include an integrated controller for evaluating the inertial variable, in particular the first recorded or second recorded inertial variable, for the provision of the interrupt signal, in particular the first or second interrupt signal. Further additionally or alternatively, the device can include a main controller or target controller for counting the duration, in particular and the further duration, in particular and monitoring whether the counted duration reaches the immobility duration, in particular and whether the counted further duration reaches the position duration. Further additionally or alternatively, the counting can be in 1-second steps. Further additionally or alternatively, the already counted duration can be reset, in particular to 0 s, if the second interrupt signal is no longer provided, in particular and the already counted duration has not yet reached the immobility duration. Further additionally or alternatively, the already counted further duration can be reset, in particular to 0 s, if the second recorded inertial variable or the variable based thereon no longer falls below the inclination limiting value, in particular and the already counted further duration has not yet reached the position duration. Moreover, reference is made to the technical literature.

In one refinement of the invention, the at least one inertial sensor unit is designed to record the at least one inertial variable in three axes, which are in particular orthogonal to one another. In particular, the nonvertical position criterion is that the second recorded inertial variable in a vertical axis or the variable based thereon falls below the inclination limiting value for the position duration. This enables the fall to be detected particularly well. In particular, the at least one inertial sensor unit can include, in particular can be, three inertial sensor units, in particular acceleration sensor units. The at least one inertial variable can include, in particular can be, three inertial variables, in particular acceleration variables. Additionally or alternatively, the position can be calculated in ° (degrees), in particular by means of the main controller. Further additionally or alternatively, the second recorded inertial variable in the vertical axis or the variable based thereon in the vertical position can be 1 g and in the nonvertical, in particular horizontal, position can be 0 g. Moreover, reference is made to the technical literature.

In one refinement of the invention, the person wears a head, face, eye, and/or hearing protection device, in particular protective glasses, headphones, and/or a headset. The head, face, eye, and/or hearing protection device includes the inertial sensor unit. This enables the inertial sensor unit to be worn particularly well. In particular, the head, face, eye, and/or hearing protection device can be a protective helmet. Additionally or alternatively, the headset can be wireless. Moreover, reference is made to the technical literature.

In one refinement of the invention, the transmission of the alarm information includes wireless transmission in a mesh network, in particular executed by means of the head, face, eye and/or hearing protection device, the protective glasses, the headphones, and/or the headset, including wireless transmission units in the mesh network. This enables the transmission particularly well and/or, in particular therefore, detecting particularly well whether the person requires aid, in particular in a forest. In particular, the term “wireless” can be used anonymously for the term “cable-free”. Additionally or alternatively, the mesh network can be defined by the transmission units. Moreover, reference is made to the technical literature.

In particular, the output can be acoustic, for example by means of the headset, and/or optical, in particular on a visor of the head, face, eye, and/or hearing protection device, in particular the protective glasses, for example by means of a head-up display and/or a head-mounted display. Moreover, reference is made to the technical literature.

In one refinement of the invention, the person wears an, in particular the, device. The device includes the inertial sensor unit, at least one functional unit, and a person-operable release and blocking unit. The functional unit is designed to execute at least one function, in particular wireless communication. The function is different from detecting the fall. The release and blocking unit is designed to release and to block the detection of the fall independently of the execution of the function. The method is executed if it is released by means of the release and blocking unit. The method is not executed if it is blocked by means of the release and blocking unit. This enables the execution of the function in any case and the execution of the method depending on the case and/or, in particular therefore, enables a false alarm to be avoided. In particular, the device can be the head, face, eye, and/or hearing protection device. Additionally or alternatively, the functional unit and/or the release and blocking unit can be electrical. Further additionally or alternatively, the execution of the function can be automatic and/or by means of the transmission units. Further additionally or alternatively, the release and blocking unit can be person-operable by means of a button. Moreover, reference is made to the technical literature.

In particular, the inertial sensor unit, in particular the device, can have a maximum mass of 10 kg (kilogram), in particular 5 kg, in particular 2 kg, in particular 1 kg, in particular 0.5 kg, in particular 0.2 kg, in particular 0.1 kg, in particular 0.05 kg.

The device according to the invention is for, in particular designed for detecting the fall of the person by means of the at least one inertial sensor unit of the device. The device is designed to be worn, in particular is worn, by the person on the body part, in particular their head. The inertial sensor unit is designed to record the at least one inertial variable. The device is designed:
For monitoring whether the at least one first recorded inertial variable or the variable based thereon meets the impact criterion. The impact criterion is characteristic for the impact of the body part.
If the impact criterion is met, for monitoring whether the at least one second recorded inertial variable or the variable based thereon meets the immobility criterion and the nonvertical position criterion. The second recorded inertial variable is recorded chronologically after the first inertial variable. The immobility criterion is characteristic for the immobility of the body part for the immobility duration. The nonvertical position criterion is different from the immobility criterion. The nonvertical position criterion is characteristic for the nonvertical position of the body part for the position duration.
If the immobility criterion and the nonvertical position criterion are met, for outputting and/or transmitting the alarm information, in particular about the detected fall.

The device can enable the same advantage(s) as mentioned above for the method. In particular, the device can be for, in particular designed for, in particular automatic, execution of the method as mentioned above. Additionally or alternatively, the device can include a computing unit and/or a processor and/or a microcontroller and/or a storage unit and/or a computer. Moreover, reference is made to the technical literature.

The computer program according to the invention is for, in particular automatic, execution of the method as mentioned above and/or by means of the device as mentioned above. The computer program can enable the same advantage(s) as mentioned above for the method. In particular, the computer program can be a computer program product. Additionally or alternatively, the computer program can be stored on a computer-readable (storage) medium. In other words: the computer program can include commands or instructions, in particular executable by means of the device, in particular which, upon being executed or upon execution by means of or by the device, prompt or cause it to execute the method as mentioned above:
For monitoring whether the at least one first recorded inertial variable or the variable based thereon meets the impact criterion. The impact criterion is characteristic for the impact of the body part.
If the impact criterion is met, for monitoring whether the at least one second recorded inertial variable or the variable based thereon meets the immobility criterion and the nonvertical position criterion. The second recorded inertial variable is recorded chronologically after the first inertial variable. The immobility criterion is characteristic for the immobility of the body part for the immobility duration. The nonvertical position criterion is different from the immobility criterion. The nonvertical position criterion is characteristic for the nonvertical position of the body part for the position duration.
If the immobility criterion and the nonvertical position criterion are met, for outputting and/or transmitting the alarm information, in particular about the detected fall.

In yet other words, the commands can describe the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of a device according to the invention during the execution of a method according to the invention of a computer program according to the invention.

FIG. 2 is a schematic view of a device according to the invention during the execution of a method according to the invention of a computer program according to the invention.

FIG. 3 is a function flow chart of the method.

### DETAILED DESCRIPTION OF THE DRAWINGS

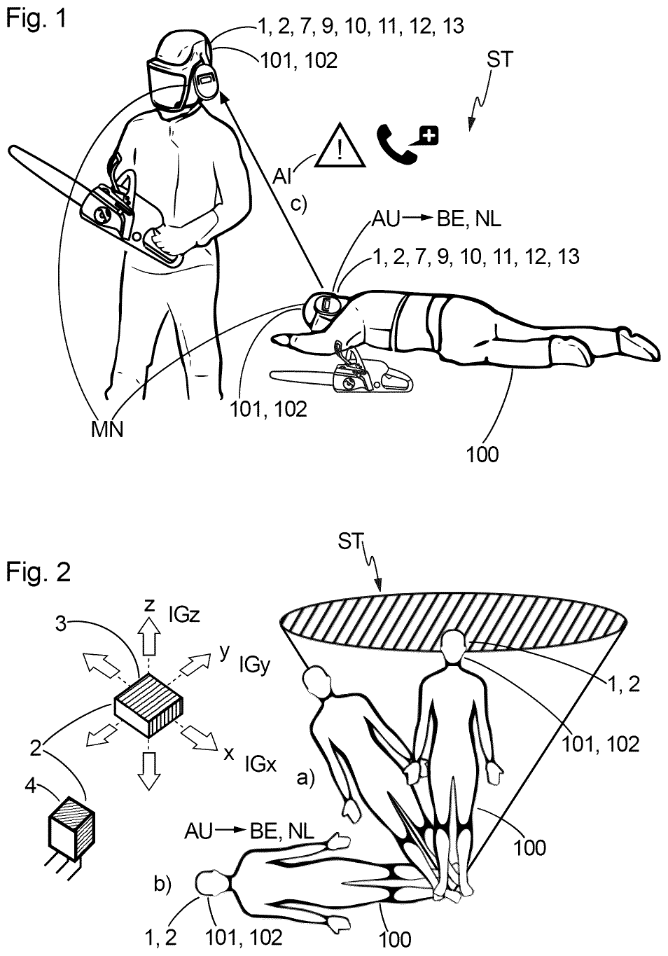

FIGS. 1 to 3 show a method of a computer program according, and a device 1, for detecting a fall ST of a person 100 by means of at least one inertial sensor unit 2, in particular of the device 1.

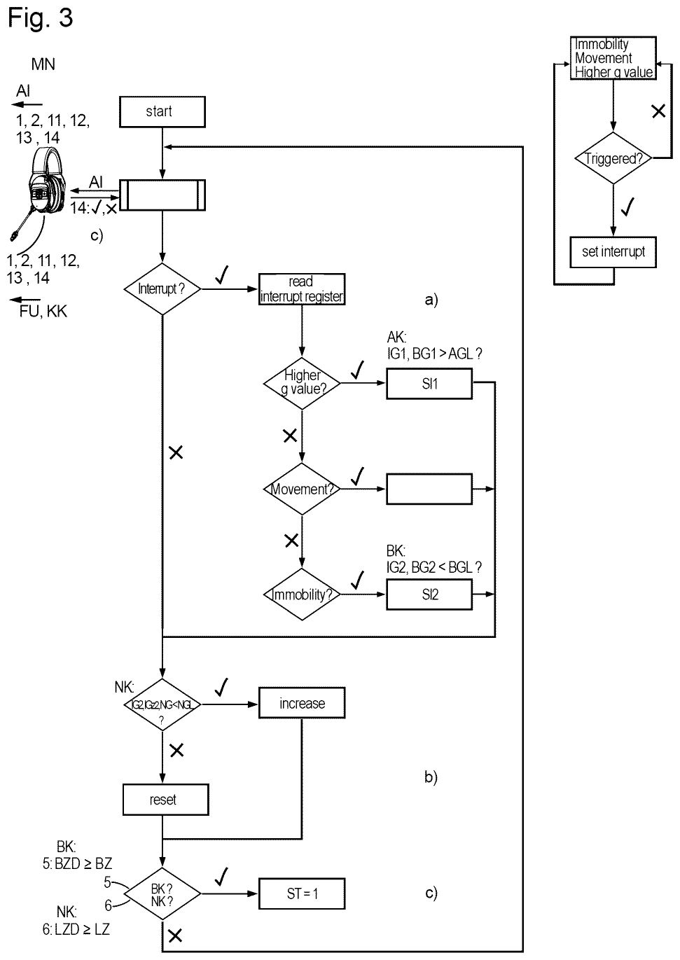

The device 1 is designed to be worn, in particular is worn, by the person 100 on a body part 101, in particular their head 102, or the inertial sensor unit 2 is worn by the person 100 on the body part 101, in particular their head 102, as shown in FIGS. 1 and 2. The inertial sensor unit 2 is designed to record, in particular records, at least one inertial variable IG, as shown in FIGS. 2 and 3.

The method includes the following steps:
a) Monitoring whether at least one first recorded inertial variable IG1 or a variable based thereon meets an impact criterion AK, as shown in FIG. 3. The impact criterion AK is characteristic for an impact AU of the body part 101, as shown in FIGS. 1 and 2.
b) If the impact criterion AK is met, monitoring whether at least one second recorded inertial variable IG2 or a variable based thereon meets an immobility criterion BK and a nonvertical position criterion, in particular a horizontal position criterion, NK, as shown in FIG. 3. The second recorded inertial variable IG2 is recorded chronologically after the first inertial variable IG1. The immobility criterion BK is characteristic for an immobility BE of the body part 101 for an immobility duration BZ, in particular of at least 30 s, as shown in FIGS. 1 and 2. The nonvertical position criterion NK is different from the immobility criterion BK. The nonvertical position criterion NK is characteristic for a nonvertical, in particular horizontal, position NL of the body part 101 for a position duration LZ, in particular of at least 30 s.
c) If the immobility criterion BK and the nonvertical position criterion NK are met, outputting and/or transmitting alarm information AI, in particular about the detected fall ST, as shown in FIGS. 1 and 3.

The device 1 is designed:
For monitoring, in particular monitors, whether the at least one first recorded inertial variable IG1 or the variable based thereon meets the impact criterion AK. The impact criterion AK is characteristic for the impact AU of the body part 101.
If the impact criterion AK is met, for monitoring, in particular monitors, whether the at least one second recorded inertial variable IG2 or the variable based thereon meets the immobility criterion BK and the nonvertical position criterion NK. The second recorded inertial variable IG2 is recorded chronologically after the first inertial variable IG1. The immobility criterion BK is characteristic for the immobility BE of the body part 101 for the immobility duration BZ. The nonvertical position criterion NK is different from the immobility criterion BK. The nonvertical position criterion NK is characteristic for the nonvertical position NL of the body part 101 for the position duration LZ.
If the immobility criterion BK and the nonvertical position criterion NK are met, for outputting and/or transmitting, in particular outputs and/or transmits, the alarm information AI, in particular about the detected fall ST.

In detail, the inertial sensor unit 2 includes an acceleration sensor unit 3, and in particular a rotation rate sensor unit and/or an inclination switch unit 4, as shown in FIG. 2. The inertial variable IG includes an acceleration variable BG, and in particular a rotation rate variable and/or an inclination variable NG, as shown in FIG. 3.

In alternative exemplary embodiments, the inertial sensor unit may not include the rotation rate sensor unit and/or the inclination switch unit. The inertial variable may not include the rotation rate variable and/or the inclination variable NG.

Furthermore, the impact criterion AK is that the first recorded inertial variable IG1, in particular acceleration variable BG1, or the variable based thereon exceeds an impact limiting value AGL, in particular characteristic for at least 6 g. Additionally or alternatively, the immobility criterion BK is that the second recorded inertial variable IG2, in particular acceleration variable BG2, or the variable based thereon falls below an immobility limiting value BGL, in particular characteristic for at most 0.5 g, for the immobility duration BZ. In particular, the impact limiting value AGL is greater, in particular at least 12 times greater, than the immobility limiting value BGL. Further additionally or alternatively, the nonvertical position criterion NK is that the second recorded inertial variable IG2, in particular inclination variable NG, or the variable based thereon falls below an inclination limiting value NGL, in particular characteristic for at most 0.5 g and/or at most 45°, for the position duration LZ.

In detail, the person 100 wears the device 1. The device 1 includes the inertial sensor unit 2 and a time counter unit 5. The inertial sensor unit 2 is designed to provide, in particular provides, a first interrupt signal SI1 at the time counter unit 5 as long as the first recorded inertial variable IG1 or the variable based thereon exceeds the impact limiting value AGL. The inertial sensor unit 2 is designed to provide, in particular provides, a second interrupt signal SI2 at the time counter unit 5 as long as the second recorded inertial variable IG2 or the variable based thereon falls below the immobility limiting value BGL. The second interrupt signal SI2 is different from the first interrupt signal SI1. The time counter unit 5 is designed to count, in particular counts, a duration BZD, in particular immediately, chronologically after the provision of the first interrupt signal SI1. During the duration BZD, the second interrupt signal SI2 is provided. The immobility criterion BK is that the counted duration BZD reaches the immobility duration BZ. In particular, the device 1 includes a further time counter unit 6. The further time counter unit 6 is designed to count, in particular counts, a further duration LZD, in particular immediately, chronologically after the provision of the first interrupt signal SI1. During the further duration LZD, the second recorded inertial variable IG2 or the variable based thereon falls below the inclination limiting value NGL. The nonvertical position criterion NK is that the counted further duration LZD reaches the position duration LZ.

In addition, the at least one inertial sensor unit 2 is designed to record the at least one inertial variable IGx, IGy, IGz in three axes x, y, z, which are in particular orthogonal to one another, as shown in FIG. 2. In particular, the nonvertical position criterion NK is that the second recorded inertial variable IGz2 in a vertical axis z or the variable based thereon falls below the inclination limiting value NGL for the position duration LZ, as shown in FIG. 3.

Furthermore, the person 100 wears a head, face, eye, and/or hearing protection device 7, in particular protective glasses 9, headphones 10, and/or a headset 11, as shown in FIGS. 1 and 3. The head, face, eye, and/or hearing protection device 7 includes the inertial sensor unit 2.

Moreover, the transmission of the alarm information AI includes a wireless transmission in a mesh network MN, in particular executed by means of the head, face, eye, and/or hearing protection device 7, the protective glasses 9, the headphones 10, and/or the headset 11, including wireless transmission units 12 in the mesh network MN.

Furthermore, the person 100 wears the device 1. The device 1 includes the inertial sensor unit 2, at least one functional unit 13, and a person-operable release and blocking unit 14. The functional unit 13 is designed to execute, in particular executes, at least one function FU, in particular a wireless communication KK. The function FU is different from the detection of the fall ST. The release and blocking unit 14 is designed to release and to block, in particular releases or blocks, the detection of the fall ST independently of the execution of the function FU. The method is executed if it is released by means of the release and blocking unit 14. The method is not executed if it is blocked by means of the release and blocking unit 14.

As the exemplary embodiments shown and explained above make clear, the invention provides an advantageous method and an advantageous device for detecting a fall of a person by means of at least one inertial sensor unit and an advantageous computer program for executing such a method and/or by means of such a device, which have/has the improved properties.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for detecting a fall of a person via at least one inertial sensor unit, which is worn by the person on a body part, and which is designed to record at least one inertial variable, the method comprising the steps of:
a) monitoring whether at least one first recorded inertial variable or a variable based thereon meets an impact criterion, which is characteristic for an impact of the body part;
b) when the impact criterion is met, monitoring whether at least one second recorded inertial variable, which is recorded chronologically after the first inertial variable, or a variable based thereon, meets: (i) an immobility criterion, which is characteristic for an immobility of the body part for an immobility duration, and (ii) a nonvertical position criterion, which is different from the immobility criterion and is characteristic for a nonvertical position of the body part for a position duration; and
c) when the immobility criterion and the nonvertical position criterion are met, outputting and/or transmitting alarm information about a detected fall.

2. The method according to claim 1, wherein one or more of:
the immobility duration is of at least 30 seconds,
the nonvertical position criterion is a horizontal position criterion, or
the position duration is of at least 30 seconds.

3. The method according to claim 1, wherein
the inertial sensor unit includes an acceleration sensor unit, and
the inertial variable includes an acceleration variable.

4. The method according to claim 3, wherein
the inertial sensor unit includes a rotation rate sensor unit and/or an inclination switch unit, and
the inertial variable includes a rotation rate variable and/or an inclination variable.

5. The method according to claim 1, wherein one or more of:
the impact criterion is that the first recorded inertial variable, or the variable based thereon, exceeds an impact limiting value,
the immobility criterion is that the second recorded inertial variable, or the variable based thereon, falls below an immobility limiting value for the immobility duration, wherein the impact limiting value is greater than the immobility limiting value, or
the nonvertical position criterion is that the second recorded inertial variable, or the variable based thereon, falls below an inclination limiting value for the position duration.

6. The method according to claim 3, wherein one or more of:
wherein the impact criterion is that a first recorded acceleration variable, or the variable based thereon, exceeds an impact limiting value characteristic for at least 6 g,
wherein the immobility criterion is that a second recorded acceleration variable, or the variable based thereon, falls below an immobility limiting value characteristic for at most 0.5 g, for the immobility duration, wherein the impact limiting value is at least 12 times greater than the immobility limiting value, or
wherein the nonvertical position criterion (NK) is that a second recorded inclination variable, or the variable based thereon falls, below an inclination limiting value characteristic for at most 0.5 g and/or at most 45° for the position duration.

7. The method according to claim 5,
wherein the person wears a device, which includes the inertial sensor unit and a time counter unit,
wherein the inertial sensor unit is designed to provide a first interrupt signal at the time counter unit as long as the first recorded inertial variable or the variable based thereon exceeds the impact limiting value,
wherein the inertial sensor unit is designed to provide a second interrupt signal, which is different from the first interrupt signal, at the time counter unit as long as the second recorded inertial variable or the variable based thereon falls below the immobility limiting value, and
wherein the time counter unit is designed to count a duration, chronologically after the provision of the first interrupt signal, during which the second interrupt signal is provided, and
wherein the immobility criterion is that the counted duration reaches the immobility duration.

8. The method according to claim 7, wherein
the device includes a further time counter unit, which is designed to count a further duration, chronologically after the provision of the first interrupt signal, during which the second recorded inertial variable or the variable based thereon falls below the inclination limiting value, and wherein the nonvertical position criterion is that the counted further duration reaches the position duration.

9. The method according to claim 1, wherein
the inertial sensor unit is designed to record the at least one inertial variable in three axes, which are orthogonal to one another,
wherein the nonvertical position criterion is that the second recorded inertial variable in a vertical axis or the variable based thereon falls below the inclination limiting value for the position duration.

10. The method according to claim 1, wherein
the person wears a head, face, eye, and/or hearing protection device, which includes the inertial sensor unit.

11. The method according to claim 10, wherein the protection device is protective glasses, headphones, and/or a headset.

12. The method according to claim 10,
wherein the transmission of the alarm information includes a wireless transmission in a mesh network, executed by the head, face, eye, and/or hearing protection device including wireless transmission units in the mesh network.

13. The method according to claim 1, wherein
the person wears a device which includes the inertial sensor unit, at least one functional unit and a person-operable release and blocking unit,
the functional unit is designed to execute at least one function, including a wireless communication, which is different from the detection of the fall, and
wherein the release and blocking unit is designed to release and to block the detection of the fall independently of the execution of the function,
wherein the method is executed when it is released by the release and blocking unit, and wherein the method is not executed when it is blocked by the release and blocking unit.

14. A device for detecting a fall of a person, comprising:
at least one inertial sensor unit,
wherein the device is designed to be worn by the person on a body part, and wherein the inertial sensor unit is designed to record at least one inertial variable,
wherein the device is operatively configured to:
monitor whether at least one first recorded inertial variable, or a variable based thereon, meets an impact criterion, which is characteristic for an impact of the body part,
when the impact criterion is met, monitor whether at least one second recorded inertial variable, which is recorded chronologically after the first inertial variable, or a variable based thereon, meets: (i) an immobility criterion, which is characteristic for an immobility of the body part for an immobility duration, and (ii) a nonvertical position criterion, which is different from the immobility criterion and is characteristic for a nonvertical position of the body part for a position duration, and
when the immobility criterion and the nonvertical position criterion are met, to output and/or transmit alarm information about the detected fall.

15. A computer product comprising a non-transitory computer readable medium having stored thereon program code which, when executed by one or more processors, carries out the acts of:
a) monitoring whether at least one first recorded inertial variable or a variable based thereon meets an impact criterion, which is characteristic for an impact of the body part;
b) when the impact criterion is met, monitoring whether at least one second recorded inertial variable, which is recorded chronologically after the first inertial variable, or a variable based thereon, meets: (i) an immobility criterion, which is characteristic for an immobility of the body part for an immobility duration, and (ii) a nonvertical position criterion, which is different from the immobility criterion and is characteristic for a nonvertical position of the body part for a position duration; and
c) when the immobility criterion and the nonvertical position criterion are met, outputting and/or transmitting alarm information about a detected fall.
